(19) United States
(12) Patent Application Publication
(10) Pub. No.: US 2002/0003107 A1
(43) Pub. Date: Jan. 10, 2002

(54) Centrifugal separator formed as a cyclone

(76) Inventor: Hans-Peter Kampfer, Herborn (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 09/858,875

(22) Filed: Mar. 15, 2001

(30) Foreign Application Priority Data
Mar. 17, 2000 (DE) 10013337.1

(51) Int. Cl. B01D 17/038

(52) U.S. Cl. 210/512.1; 55/459.1; 210/512.3

(57) ABSTRACT

A centrifugal separator for solids and fluids can have its vortex chamber and an outlet duct internally aligned as a hard material or wholly formed from a hard material which is preferably selected from the group which consists of sintered titanium carbide, titanium nitride, titanium boride, zirconium carbide, zirconium diboride, niobium carbide, tantalum carbide, chromium carbide, chromium boride, molybdenum silicide, and tungsten carbide with a nickel or cobalt binder, and cubic boron nitride, boron carbide, silicon carbide and corundum.

### FIELD OF THE INVENTION

My present invention relates to a centrifugal separator formed as a cyclone for the separation of solids from liquids or gases and, more particularly, to a centrifugal separator having a vortex chamber to which a tubular outlet passage or duct is connected.

### BACKGROUND OF THE INVENTION

A vortex chamber into which a fluid carrying entrained solids can be admitted, can generate a cyclonic or vortex flow of the fluid from which the solids are separated because of their greater momentum, while the fluid is withdrawn axially through an outlet duct.

In the vortex chamber itself and the tubular outlet duct, significant wear can occur, especially when the solids are abrasive materials. This wear gives rise to rapid deterioration of the cyclone so within a relatively short operating time, the vortex chamber, other parts of the cyclone or the entire cyclone must be replaced. The apparatus in which the cyclone is incorporated then must be brought to standstill for a considerable time to allow replacement and significant costs are then engendered by the need to replace the cyclone or the parts thereof.

There are cyclones in which replaceable parts are provided for those portions subjected to the greatest wear. Such cyclones need not be replaced entirely since only the parts which become worn need then be removed and replaced by new or reconstructed parts. While this amounts to some saving in cost, it nevertheless requires the cyclone and the apparatus in which it is incorporated to be brought to standstill for considerable periods of time and the costs which are engendered by the need to bring the cyclone to standstill are not materially reduced.

There are also cyclones which have at their wear-sensitive areas parts formed from wear-resistant materials. These cyclones have longer lives and the frequency of standstill periods is somewhat reduced. However, since the parts involved are nevertheless subject to significant wear, it is still a requirement that those parts be replaced and those parts of the cyclone which are not constructed of the wear-resistant materials be also replaced from time to time. The cost of bringing the apparatus to standstill even for such less frequent periods, remains substantial.

### OBJECTS OF THE INVENTION

It is, therefore, the principal object of the present invention to provide a centrifugal separator or cyclone in which the wear can be reduced still more significantly, the standstill periods for replacement or maintenance are even less frequent and the operating cost of the cyclones or the apparatus in which it is incorporated is reduced by comparison with prior cyclone systems.

Another object of this invention is to provide a centrifugal separator system in which the need for shutting down the apparatus for replacement or maintenance is brought practically to zero.

A further object of the invention is to provide an improved cyclone which is free from drawbacks of earlier systems and can be operated more economically than heretofore.

### SUMMARY OF THE INVENTION

These objects and others which will become apparent hereinafter are attained, in accordance with the invention in that the cyclone, which may have a configuration of a conventional cyclone with the vortex chamber and its tubular or pipe-like discharge or outlet duct, has at least the inner surfaces of the vortex chamber and at least the inner surfaces of the tubular outlet duct from a powder metallurgically made sintered hard material. Such hard materials can be, for example, titanium carbide, titanium nitride, titanium diboride, zirconium carbide, zirconium diboron, niobium carbide, tantalum carbide, chromium carbide, chromium boride, molybdenum silicide and tungsten carbide with a binder, especially of nickel or cobalt. Especially important are the carbides listed. According to another aspect of the invention at least the inner surfaces of the vortex chamber and the tubular outlet duct are composed of a nonmetallic hard material, for instance, cubic boron nitride, boron carbide, silicon carbide or corundum.

The centrifugal separator for the separation of solids from a fluid thus comprises, according to the invention:

a cyclone-forming member configured to generate a vortex flow of a fluid having solids entrained therein; and

a tubular member connected axially to the cyclone-forming member and forming an outlet duct therefor, at least an inner surface of at least one of the members being composed of a hard material selected from the group which consists of powder-metallurgically produced sintered hard materials and nonmetallic hard materials.

Metallic or nonmetallic hard materials of the aforedescribed type have been found to be excellent in preventing or limiting the frictional wear which arises in cyclones of the type described of all configurations.

With the cyclones of the invention, all of the parts subject to wear by contact with the vortex and thus all of the parts which are subject to high wear are protected. The hard materials can constitute the parts which are subject to wear or applied as a coating to them. This applies to the parts forming the vortex chamber and the parts constituting the outlet duct. The outlet duct can also be protected by providing a tubular-shaped body of the hard material which is introduced into the outlet duct. A rigid connection between the tubular duct and the metallic or nonmetallic hard material-shaped body introduced into the device can be effected by shrinking the outer part, usually of steel, onto the metallic or nonmetallic hard material part.

The inner surfaces of the chamber and the outlet duct can be provided with the hard material by hard phase diffusion methods or by the diffusion of hard material phases as a coating thereon. The wear resistance of all of the inner surfaces provided with the hard material is thus substantially increased. The cyclone thus can be used when the fluid entrained highly abrasive, solids for example, sand.

The invention permits the hard facing of the internal surfaces of the chamber and the outlet duct without altering the inner contours of the latter with practically elimination of the frictional wear an assurance that the operating efficiency of the cyclone will remain constant.

According to a feature of the invention the entire vortex chamber and/or the entire outlet duct can be constituted of the metallic or nonmetallic hard material. While this requires an increased amount of the hard material, the production of the vortex chamber and the outlet duct or parts thereof is comparatively more economical. When, moreover, the members are constituted entirely of the metallic or nonmetallic hard material, it is possible to significantly reduce the wall thicknesses thereof.

The vortex chamber and the outlet duct can each be formed from a plurality of parts which are held together by connecting elements and a connecting element can serve to attach the outlet duct to the vortex chamber. This allows simple and rapid assembly and disassembly of the cyclone.

When the vortex chamber is composed of at least two parts, interconnected by connecting elements, the construction and configuration of the vortex chamber can be altered to reflect the purpose for which the cyclone is to be used.

Advantageously, the tubular outlet duct is likewise composed of at least two parts interconnected by a connecting element. This allows the parts to be of a simpler nature and more readily manufactured and it facilitates handling of the parts. The provision of the vortex chamber or the outlet duct as a plurality of parts allows the cyclone to be built into the apparatus in a simpler and more economical manner.

The connecting elements can be composed of steel and can be shrunk at least in part on the parts to be connected thereby. A rapid and simple connection can be provided when the connecting elements form screw connections. Connecting elements can also be applied with adhesives or with glue.

The connecting elements may also be composed of synthetic resin material or formed as sleeves which, for example, can be affixed in place by adhesives. The connecting elements can be fabricated from a synthetic resin impregnated strip which is applied to the parts of the cyclone to be interconnected before cross-linking and after cross-linking and hardening forms a rigid sheath.

To protect the cyclone against shock forces, at least the tubular outlet duct is provided with a reinforcement which can be a tube of metal, forced over the duct and constituted especially of aluminum. Alternatively, a synthetic resin material can serve as the reinforcement or the reinforcement can be a rubber. The reinforcement made from a synthetic resin layer or a plastic tube or a strip impregnated with the synthetic resin or a mat soaked with the synthetic resin is used. The strip or mat is applied prior to cross-linking and forms a solid upon hardening.

The rubber layer can be applied in the form of a rubber tube, coating or the like which can be vulcanized to the parts to which the rubber is applied.

Depending upon the configuration and arrangement of the reinforcement and the use of the cyclone, the reinforcement can simultaneously serve as the connecting element for connecting the parts of the cyclone together.

### BRIEF DESCRIPTION OF THE DRAWING

The above and other objects, features, and advantages will become more readily apparent from the following description, reference being made to the accompanying drawing in which:

FIG. 1 is a longitudinal section through a cyclone for the separation of solids from fluids utilizing centrifugal force;

FIG. 2 is a view similar to FIG. 1 of another cyclone;

FIG. 3 is a front view of the vortex chamber of the cyclone shown in FIG. 1;

FIG. 4 is a side view of the vortex chamber of FIG. 3;

FIG. 5 is a front view of the vortex chamber of the cyclone of FIG. 2; and

FIG. 6 is a side view of the vortex chamber shown in FIG. 5.

### SPECIFIC DESCRIPTION

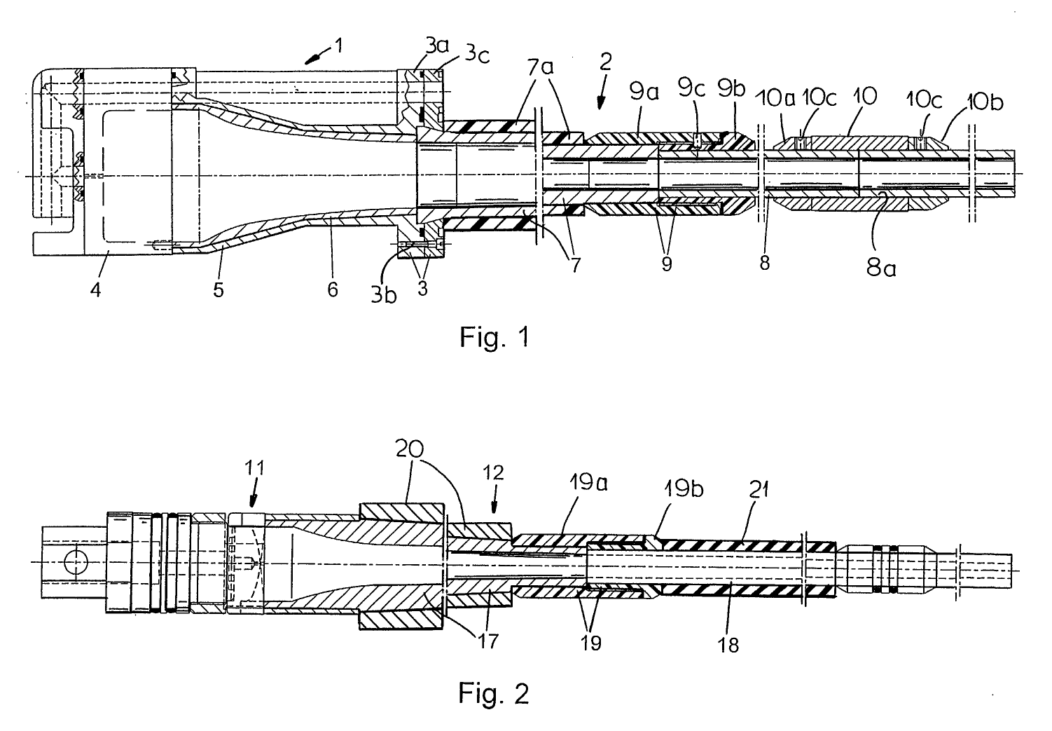

The cyclone shown in FIG. 1 comprises a vortex chamber 1 and a tubular outlet duct 2 which are connected together by connecting elements 3. In particular, the connecting element 3 in this embodiment can include a flange 3a on the conical member 5 of the vortex chamber which can be composed of steel and is shrunk onto a funnel-shaped insert 6 composed of one of the metallic or nonmetallic hard materials mentioned previously.

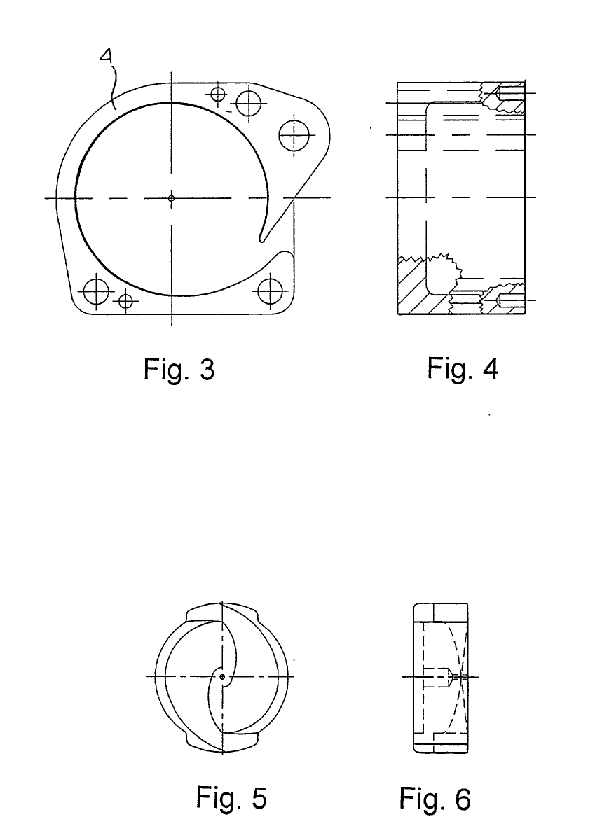

The conical portion 5 communicates with a cylindrical part 4 of the vortex chamber which can have a configuration shown in FIG. 3. The flange 3a is connected by bolts 3b with a ring 3c which attaches a first part 7 of the outlet duct to the cyclone forming member 5, 6 and is composed entirely of one of the metallic or nonmetallic hard materials mentioned previously. The part 7 can be surrounded by a plastic or rubber reinforcement 7a and can be joined to a second part 8 of the outlet duct 2 also completely formed from one of the hard materials by a connecting element 9. In this embodiment, the connecting element 9 is comprised of two sleeves 9a and 9b composed of plastic and adhesively bonded to the parts 7 and 8 and interconnected by a set screw 9c. The cylindrical part 4 is also completely composed of the metallic or nonmetallic hard material. A steel sleeve 10 may be shrunk onto the parts 8 and 8a of the outlet duct and can be located between steel rings 10a and 10b held in place by set screws 10c.

In the embodiment of FIG. 2, the vortex chamber 11 constituting the cyclone forming member and the outlet duct 12 are composed of tubular parts 17 and 18 connected together by a connecting element 19 formed from two plastic sleeves 19a and 19b as described for the connecting element 9.

Aluminum or other light metal outer liners can be provided on the parts 17 and 18 composed of the hard material as represented at 20 or a rubber tube 21 may be drawn over the parts. As will be apparent from FIGS. 3 and 4 as well as from FIGS. 5 and 6, the vortex chambers can have a variety of configurations.

I claim:

1. A centrifugal separator for the separation of solids from a fluid, comprising:
a cyclone-forming member configured to generate a vortex flow of a fluid having solids entrained therein; and
a tubular member connected axially to said cyclone-forming member and forming an outlet duct therefor, at least an inner surface of at least one of said members being composed of a hard material selected from the group which consists of powder-metallurgically produced sintered hard materials and nonmetallic hard materials.

2. The centrifugal separator defined in claim 1 wherein said inner surface is constituted by a hard material selected from the group which consists of sintered titanium carbide, titanium nitride, titanium boride, zirconium carbide, zirconium diboride, niobium carbide, tantalum carbide, chromium carbide, chromium boride, molybdenum silicide, and tungsten carbide with a nickel or cobalt binder, and cubic boron nitride, boron carbide, silicon carbide and corundum.

3. The centrifugal separator defined in claim 1 wherein said inner surface is a surface hardened by hard material phase diffusion or the deposition of a hard material phase as a coating thereon.

4. The centrifugal separator defined in claim 2 wherein at least one of said members is composed entirely of said hard material.

5. The centrifugal separator defined in claim 1 wherein said members are separate elements interconnected by a connecting element.

6. The centrifugal separator defined in claim 5 wherein at least one of said members consists of at least two parts interconnected by a connecting element.

7. The centrifugal separator defined in claim 6 wherein at least one of said connecting elements is composed of steel.

8. The centrifugal separator defined in claim 6 wherein at least one of said connecting elements forms a screw connection.

9. The centrifugal separator defined in claim 6 wherein at least one of said connecting elements consists of a member shrunk onto the parts connected thereby.

10. The centrifugal separator defined in claim 6 wherein at least one of said connecting elements is composed of a synthetic resin material.

11. The centrifugal separator defined in claim 1 wherein at least one of said members is provided with an outer sheath.

12. The centrifugal separator defined in claim 11 wherein said sheath is composed of a synthetic resin.

13. The centrifugal separator defined in claim 11 wherein said sheath is composed of rubber.
